(19) United States
(12) Patent Application Publication
(10) Pub. No.: US 2003/0103071 A1
(43) Pub. Date: Jun. 5, 2003

(54) User interface system for processing documents for display

(76) Inventors: William Lusen, Ambler, PA (US); Bruce M. Flamma, Phoenixville, PA (US); Frank W. Racis, Spring City, PA (US)

Correspondence Address: Siemens Corporation, Intellectual Property Department, 186 Wood Avenue South, Iselin, NJ, 08830, US

(21) Appl. No.: 10/237,487

(22) Filed: Sep. 9, 2002

Related U.S. Application Data
(60) Provisional application No. 60/318,107, filed on Sep. 8, 2001.

(51) Int. Cl. G09G 5/00

(52) U.S. Cl. 345/705

(57) ABSTRACT

The invention is directed to a system for processing data to be stored in a document-imaging system that includes a user interface for receiving one or more user commands; an object processor for retrieving at least a portion of the data object from the document imaging system and rendering the portion of the data object for viewing on the user interface, wherein the object processor is programmed for receiving and storing image and text information for the data object in response to the user command.

This is a non-provisional application of provisional application serial No. 60/318,107 by F. Racis et al. filed Sep. 8, 2001.

### FIELD OF THE INVENTION

The present invention is related to a computerized method and apparatus for managing data objects within a document-imaging system. More particularly, the present invention is related to managing a document-imaging system using a document viewer capable of indexing and annotating documents and combining text with an image overlay.

### BACKGROUND

Document-imaging systems are often used as a platform for the management of healthcare related documents and the integration of multimedia content in a client server environment. Such systems require tools for applications to acquire, store, organize, display and manage multimedia content (including traditional reports, images, voice, video, etc.). They also require an adequate mechanism to share multimedia content with healthcare applications regardless of where the content originated.

Document imaging is often used for long-term storage of patient data and hospital. This data is often received electronically from a clinical or financial system or it can be input from a paper format (e.g., scanning). Electronic data (in particular, demographic data) that is stored by the document-imaging system is often sent via electronic transactions from a third-party source. Inbound transactions from any external application are handled by a receiver application. Transactions are usually sent from the application to an interface engine, which then routes the transactions to Imaging. Imaging can receive Imaging Style Transactions, XML, or HL7 transactions. After a transaction has been received, the transaction is parsed and the database for the document-imaging system is updated. Outbound Transactions are similarly handled by a sending application.

The document-imaging platform is typically a combination of components, each of which has a specific purpose for storing, retrieving, and/or organizing binary objects in an archive. There is need for a component that is capable of allowing user to configure, maintain, and operate these components effectively remotely over the network on which the document-imaging system is being used.

Unfortunately, conventional Web browsers and the like do not provide the user with much flexibility in displaying text documents or scanned images. In fact, the TIFF image format, which is the most commonly used format, is not supported without the use of additional browser plug-ins. Users need to be able to display these documents, and view them at varying degrees of magnification. Moreover, scanned documents might need to be rotated to be easily viewable.

Documents in an imaging system may consist of raw text that is normally printed onto a preprinted form. To view the information in context, the user should be able to see both the text and a representation of the preprinted form. Since the same blank form is used for thousands of documents, it should not need to be saved individually for every document.

An additional disadvantage of conventional browsers are their inability to adequately add annotations to a document. While some annotations are simple, such as a line or box, or a block of text, other more complex annotations might need to be added, such as a captured signature. Annotations need to be added to both text and scanned documents.

While these problems have been solved individually by various software packages, none of them have integrated the required functions in a single package that can be automatically deployed to a client workstation without user intervention for use in a document-imaging system.

Accordingly, a system is needed that is capable of interfacing with each of the components of a document-imaging system in a highly efficient manner that is also user-friendly.

### SUMMARY OF THE INVENTION

The invention is directed to a system for processing data to be stored in a document-imaging system that includes a user interface for receiving one or more user commands; an object processor for retrieving at least a portion of the data object from the document imaging system and rendering the portion of the data object for viewing on the user interface, wherein the object processor is programmed for receiving and storing image and text information for the data object in response to the user command.

### BRIEF DESCRIPTION OF THE DRAWINGS

FIG. 1 is a diagram illustrating an overview of a document-imaging system incorporating the storage management system of the invention.

FIG. 2 is a diagram illustrating a preferred embodiment of the software process elements of the invention.

FIGS. 3(a)-(e) are a computer screenshots of a management user interface screen in accordance with aspects of the invention.

### DETAILED DESCRIPTION

The invention will be understood more fully from the detailed description given below and from the accompanying drawings of the preferred embodiments of the invention; which, however, should not be taken to limit the invention to a specific embodiment but are for explanation and understanding only.

The document-imaging system within which the present invention is to be used stores multimedia content in the form of documents. A document in this context is preferably a single, self-contained, data object that is comprised one or more objects. Each object is typically a single binary file. Objects are typically text reports, scanned images, word processing documents, or any other binary data generated by any application.

The document-imaging system organizes documents by filing them hierarchically into folders using a relational database. A folder in this context is simply a virtual container for a set of documents that “belong” to a specific owner. This is analogous to a typical manila folder in a filing cabinet. Similarly, filing a document into a folder is analogous to inserting a paper document into a manila folder. An “owner” is a set of indexes that uniquely identify a specific person, organization, or entity. For example, a patient is a potential “owner” of documents relating to that patient's health care record.

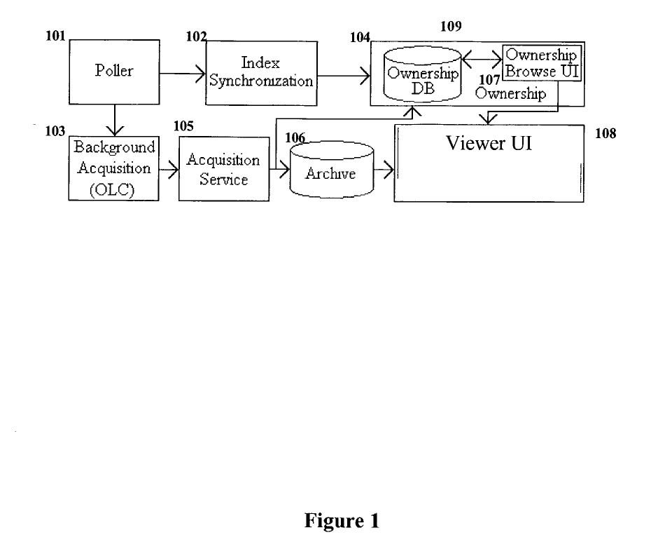

FIG. 1 illustrates a high-level overview of the functionally active components of a document-imaging system incorporating the present invention. The arrows show, in the simplest terms, how the active components relate to each other. Specifically, poller (101) detects new files to be stored or processed by the document-imaging system, and feeds them to index synchronization component (102) and/or to background acquisition component (103) depending on their contents. Index synchronization component (102) takes batched or real-time indexing information, for example, from data repository or database (109) containing a master patient index, interprets the indexing information, and passes it to ownership component (104) to create and/or update folder information.

Background acquisition component (103) processes files to be stored in the document-imaging system by breaking them apart into documents and extracting indexing information for them. These documents and their indexing information are then passed to acquisition service (105). Acquisition service (105) gathers new documents and their indexing information and routes them to storage manager (106) and to ownership component (104) so they are properly stored and associated with the correct folders. Storage manager (106) stores objects, organizes them into documents, and provides hierarchical storage management for the objects.

Ownership component (104) organizes documents by maintaining indexing information in the form of folders and also maintaining the list of documents in each folder within database (109). Ownership also preferably includes browser user interface (107), which is programmed to display, navigate, and maintain the hierarchy of folders and a summary of their contents. Browser user interface (107) is also preferably programmed to enable the display of selected documents by feeding them to the viewer user interface (108). Viewer user interface (108) renders document objects to an output device such as a screen or printer and allows navigation across multiple documents.

This document-imaging system thus preferably utilizes three types of data interfaces that are programmed to communicate with external applications to integrate multimedia content into their workflows and business processes. The interoperable user interfaces provide robust user forms (such as HTML or XML generated user input forms) that external applications may embed within their own user interface as a tightly integrated part of the application workflows. These forms relieve the application of the burden of understanding and formatting the complex multimedia information presented by the document-imaging system. Service level application interfaces use conventional data streams that represent the information stored in the document imaging system and to allow the system to intermix multimedia information with other data in the application. The background data exchange interfaces are programmed to provide communication points between the document-imaging system and an external application to share information therebetween. These interfaces are typically used by the document-imaging system to accept index information or to automatically acquire new documents.

The document imaging system preferably operates on a Microsoft Windows 2000 or Windows NT Server, although not limited thereto, and is described in that implementation herein. In this context, the present invention, as described in more detail below, preferably executes as an asynchronous service that is initiated by independent software (one example being the Poller (101)). This service is accessed preferably as a fully functional Web Service (as understood by anyone of ordinary skill in the art) or as a standard HTTP Post request using an XML as input. The Background Acquisition service is controlled by the calling software.

The present invention is directed to the viewer user interface component of the above-described document-imaging system. Viewer interface (108) allows users to view, print, and manipulate text and scanned documents from within a conventional Web browser. These manipulations include the ability to pan, rotate, and zoom the image, or add annotations to the document, as described in more detail below. Document types may include, for example, ASCII text, raster images, or a combination of ASCII text overlaid on a raster image “template.” The viewer code is preferably packaged in a Microsoft .CAB file to allow automatic downloading to Internet Explorer, avoiding the need to install the application as a browser plug-in.

Viewer interface (108) also handles the presentation of documents on target output devices. This includes presentation using a graphical user interface (GUI) (such as Web browser) on a display workstation and also using other output devices such as printers, email routing, outbound faxes, and personal digital assistant (PDA) devices. Viewer interface (108) is typically launched from within Browser interface (107) to display documents selected therein by the user. Viewer interface (108) may also communicate directly with storage manager (106) to retrieve objects that will be rendered (as discussed in more detail below). Viewer interface (108) may also be launched by external applications to display specific documents within the application's business process or workflow.

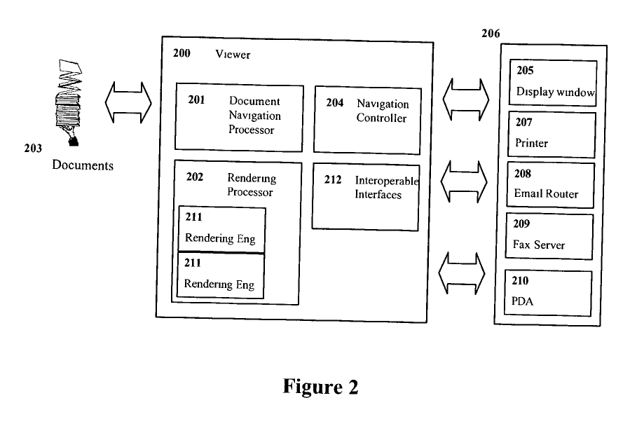

FIG. 2 is a diagram illustrating the functional elements of the software implementing viewer interface (108). As shown in FIG. 2, viewer (200) is programmed to primarily handle two main functions: navigation across documents (201) and the actual rendering of objects into visual output (202). Document navigation process (201), or paging, is programmed to present one or more documents and to provide controls for navigating through the pages/objects contained by those documents. This is primarily for displaying the object and/or information on the object.

Document navigation process (201) receives a list of documents (203) that are presented to the user along with a navigation controller (204) to go forward and backward through the related objects. The navigation control functions may include, for example: go to the first page of the first document, go to the first page of the previous document, go to the first page of the current document, go to the previous page of the current document, go to the next page of the current document, go to the last page of the current document, go to the first page of the next document, and go to the first page of the last document.

The list of documents and control functions are preferably provided to the user in document display window (205), which enables the users to navigate through the contents of one or more documents. Document display window (205) may comprise, for example, a Web browser window operating on a workstation monitor.

Rendering process (202) is programmed to transform an object into a format that is visually meaningful for target output device (206). In the situation where the object is rendered in document window (205), this transformation involves preparing the object for graphical presentation in a windowed environment. For other devices, such as printer (207), email router (208), fax server (209) or personal digital assistant (210), this means translating the object into a stream understood by the device.

Rendering process (202) is preferably programmed to interoperate with one or more rendering engines (211). Rendering engines (211) are programmed to transform the content of a document into whatever format is appropriate for sending to targeted output device (206). Each rendering engine is preferably a self-contained tool that renders files of one or more specific formats. A rendering engine may be intended for use interactively by the user and/or as a background process. Rendering engines (211) may comprise third party tools made by the software company that published the file format of the document being processed.

Alternatively, rendering engines (211) may be programmed within rendering process (202). Each rendering engine (211) may each be programmed with some unique features for providing flexibility in displaying an object, but preferably include certain common display functions such as zoom (make the object bigger or smaller on the screen) and rotate (change the orientation of the object—such as right-side-up or upside down). These rendering engines are used to render files on target output device (206), such as for viewing on document display window (205). Browser interface (107) (FIG. 1) allows viewer interface (108) to handle HTML and XML files natively, and typically renders other file formats using a third party viewer. This third party viewer may comprise rendering engine (211).

Documents stored in the document-imaging system are not always completely formatted for outputting to target output device (206). Sometimes a document should be merged with some additional static information to give meaning or structure to its contents. This static information is herein referred to as a “template”. A template may be as simple as an image over which a text document should be written or it could be as complex as an XSL style sheet used to format an XML document. Templates are preferably saved as a separate file, which has the advantage that the same image may be used for every document of a given type, dramatically reducing the storage required.

Rendering process (202) is therefore preferably programmed to render combined image and text objects and to generate and maintain file templates. Rendering process (202) is programmed to provide normal display functionality such as zoom and rotate, but it also to provides more advanced functionality such as the ability to define annotations (e.g. text notes) for a page and the ability to combine a form template (discussed below) with text files.

Raster images are one type of image file that usually comprises photographs or scanned images. These can be stored in a variety of industry-standard formats, including BMP, JPEG, PNG, and TIFF. Each document represents a single page, with the exception of TIFF, which can contain multiple pages in a single document. ASCII (text) documents consist of one or more pages. Text documents may be displayed independently, or overlaid on top of a raster image “template”.

Templates are preferably specified by a document type and file format. For example, the template used for a text formatted patient bill (e.g., such as the government defined form UB92) is typically not the same as one used for a text formatted patient face sheet. Similarly, the template used for a text formatted patient bill is typically not the same as the one used for an XML formatted patient bill.

Templates provide structure and meaning to a document, and they also provide the ability to format a document for multiple languages. If the stored document consists of the document's data (stored, for example, as an XML data source) then multiple templates may be specified, one for each language that document should support. Multi-part forms are also supported by Rendering process (202). Specifically, if the document is to be structured differently based on the recipient of the information, then several templates may be created to handle as many different ways to present the data as needed.

Templates can be of any supported raster format. If the TIFF format is used, the template can contain multiple images. This is used when different pages of the document require a different template. Examples of this are using a different template for the first page, using a different template for the last page, or alternating between templates (e.g. front and back side of page). The rules for choosing which image to use are encoded into the TIFF file.

Every document in the system is given a document type. The type of a document determines the template that will be used when displaying the document (if any) and the registration of the text. Registration defines the font used for the text, as well as the character size and position. The user may adjust the registration so that the text will align correctly with the underlying template. Page breaks occur where the document contains a form feed character, when the number of lines exceeds a value specified in the registration, or when the text would exceed the vertical bounds of the template used.

A targeted output device (206) may override a template. For example, if the template is meant to reproduce a pre-printed form and the printer for which the document is being rendered has that form loaded as pre-printed paper, then the template is not needed.

Navigation controller (204) is preferably programmed to allow the user to send commands to Rendering process (202) to maintain template registrations by adding, revising, and/or deleting the association between a document type and file format with a template and any processing parameters needed to use the template.

An annotation is a text note that may be overlayed onto a specific position on an object or page. In other words, annotations are objects that are drawn on top of the base image. This is analogous to placing a yellow sticky note on a paper document. Rendering process (202) is programmed to allow annotations to be added, modified, and deleted. They may also be rotated to different orientations on the page and use a variety of font sizes when being displayed. Annotations may thus be added to both text and raster documents. The annotations preferably do not modify the original file, and are kept in a separate file, preferably in XML format. This allows users to selectively turn the annotations on and off. Rendering process (202) is programmed to allow users to add, edit, and display annotations.

Graphic annotations include lines and boxes. Lines can be straight or freeform. Boxes can be hollow or filled. A “highlight” annotation is a box with no border and a transparent fill. Colors and line sizes of graphic annotations can be selected by the user. Text annotations are a box filled with text. All options regarding color and line for a graphic box are available for a text box. The text font, size, and color can be chosen by the user. A “sticky note” text box automatically selects a yellow background color for the text box. Rendering process (202) is programmed to allow all of the previous annotations to be moved, resized, edited, or deleted by the user.

A “rubber stamp” function programmed into rendering process (202) creates a text annotation with predefined text, color, and size. Examples are “DRAFT” or “Received Sep. 1, 2002.” The text, color, and size of each rubber stamp are chosen by the system administrator. The current date can be automatically inserted into a rubber stamp. Once a rubber stamp annotation is added, it is a normal text box.

A signature capture annotation consists of a graphical representation of a user's signature that is displayed at a specified location on the document. The signature is preferably encrypted with a hash of the document, which validates that the document has not been changed, and binds a particular signature with the document. In addition to the graphical representation of the signature, a forensically verifiable vendor-specific signature can also be attached.

It is preferred that annotations do not modify the original document. This allows annotations to be edited or disabled at any time. Annotations are stored as an XML file that the document imaging storage system will associate with the document.

Rendering process (202) is preferably programmed to allow the user to zoom from 5 to 500%, either by manually choosing a percentage or selecting a “fit to page” or “fit to width” option, which will automatically choose a percentage based upon the size of the source document and display window. If the specified zoom results in an image larger than the current display, the user may scroll the image to view the remaining portion.

Zoom may be chosen from a list, or by drawing a “rubber band” selection with the mouse. When the rubber band selection is made, the document will be scrolled and zoomed to display the chosen area. Scrolling may be done with the scroll bars or by using the mouse to perform a “pan” operation, where the user drags the image within the window.

A black-and-white scanned image will normally have a higher resolution than a monitor is capable of displaying. The user will usually reduce the size of the document to view it. Rendering process (202) is preferably programmed with two methods when zooming out. The first is pixel dropping, which simply omits a certain percentage of the pixels. While very fast, the resulting loss of information can make scanned text very difficult to read.

The other method is scale-to-gray. To make the image smaller, multiple black and white pixels are combined into a single gray pixel. The shade of the gray pixel can vary from pure black to pure white, and is determined by the percentage of pixels that are black. Scaling in this manner results in less information loss than simply dropping the pixels, resulting in a more readable document.

Rendering process (202) is also programmed with a number of other features, such as the ability to read text files that have been compressed using the well known GZIP algorithm, which reduces the storage space required for the documents and the network bandwidth required to transmit them; to support progressive loading of text documents, which allows the initial pages of the document to be viewed before the entire document is loaded; to provide a search function that allows the user to search the current document for specified text; to allow text within a document to be copied to the system clipboard and pasted into another application; to print any document it is capable of displaying, and to also print the text, raster image, and any annotations, just as the displayed document, or even print the entire document or a range of pages; and to be able to print a batch of documents as part of a single print job. Printing as a single job prevents documents from becoming intermixed with another user's documents in the printer queue, as well as reducing the number or per-job header sheets which can be produced by the operating system.

Viewer (200) also preferably includes interoperability interfaces (212), which are programmed to allow viewer (200) to be launched and operated from other components in the document-imaging system and by external applications. For example, interoperability interfaces (212) may include a process by which an external application may embed document display window (205) within it's own workflow to display documents. It may also include programming to return the first page of a single document as an image in the form of a data stream. This stream is typically used, for example, in the SRC parameter of an HTML image tag.

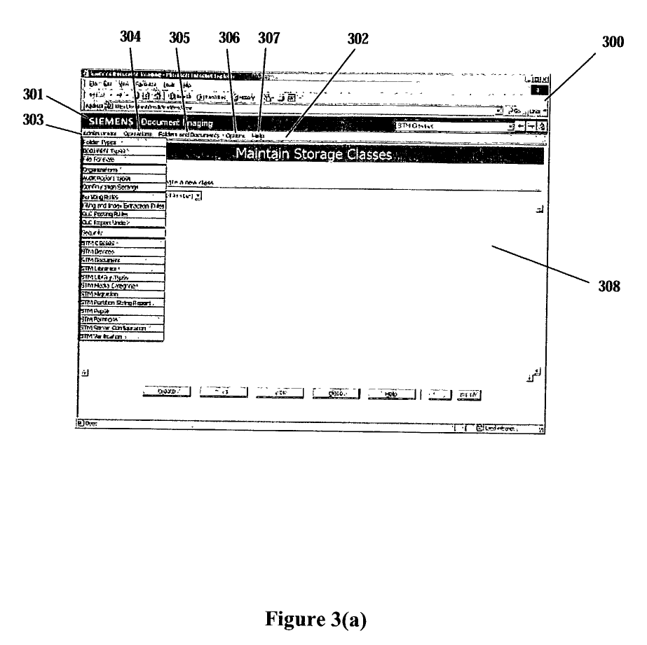

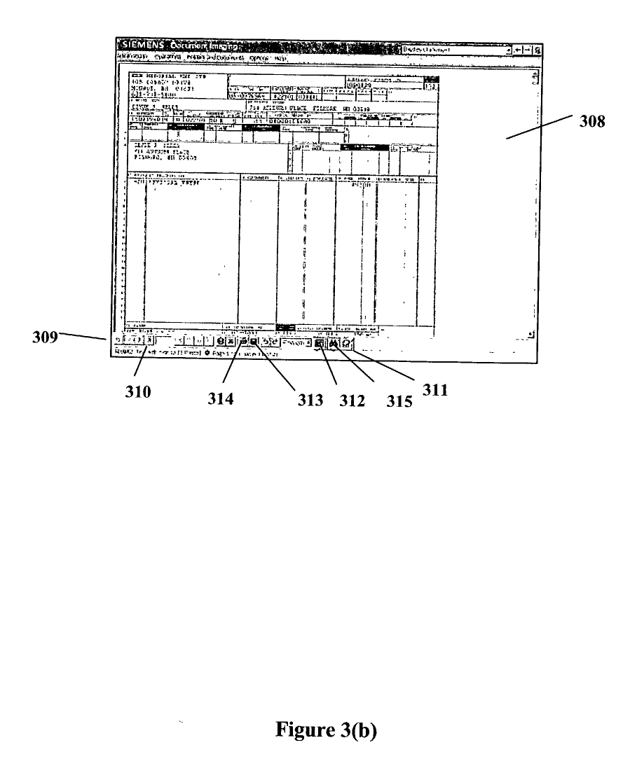

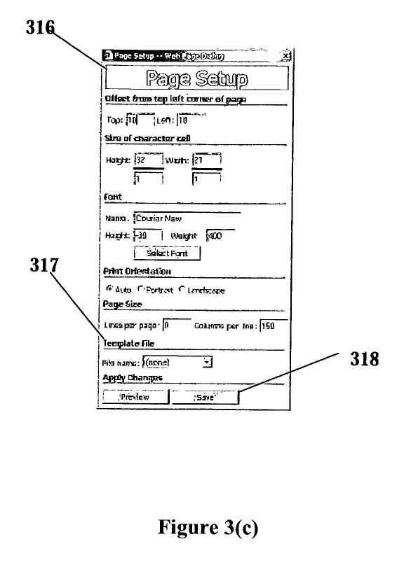

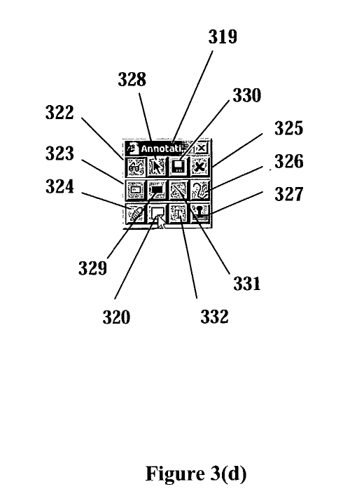

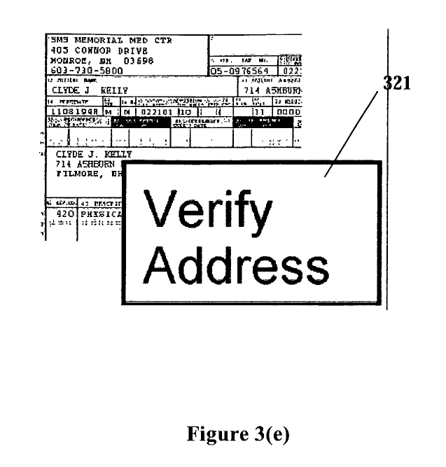

An example of how viewer (200) may visibly present information to the user via document window (205) is described in more detail below in connection with FIGS. 3(a)(e). FIG. 3(a), is a computer screenshot illustrating the user interface (300) to the document-imaging system. As shown in FIG. 3(a) and noted above, the user interface may operate as a plug-in viewer to an Internet Web browser (301), such as Microsoft's Internet Explorer (although not limited thereto). User interface (300) may include tool bar (302), having administrator menu (303), operations menu (304), folder and documents menu (305), options menu (306), and help menu (307).

Administrator menu (303) has been expanded to show all available administrative options for the document imaging system. The menu items for the image processor appear on the first three lines of administrator menu (303), namely, “Folder Types”, “Document Types”, and “File Formats”. Documents are actually retrieved under folder and documents menu (305).

FIG. 3(b) is a computer screenshot of a document displayed in the document display window (308). As shown in FIG. 3(b), document display window (308) now includes control tools (309) that allow the user to navigate the document (310), to create annotations (311), to create templates (312), to save portions of the document and this other information (313), to print portions of the documents (314), to search the documents (315), etc. The document may be initially retrieved in any conventional manner, such as drilling down through a hierarchical list of file folders and documents contained in the document-imaging system, which are displayed when folder and documents menu (305) is first selected.

For example, to create a template for this document, or document page, the user would select the page icon (312) from control tools (309), retrieving popup window (316) for the page setup, shown in FIG. 3(c). The user would then designate the template file options (317) and save the changes by clicking button (318).

To annotate a document, the user would select annotation icon (311), which would retrieve annotation toolbar (319), which is shown in FIG. 3(d). Annotation toolbar (319) appears as a floating window or as part of control tools (309) in a conventional manner. Annotation toolbar (319) contains selection icons for each of the functions described above. For example, if the user selects create sticky note icon (320), then viewer (200) creates a yellow graphical box (321), within which the user can type a text annotation. This is shown in FIG. 3(e).

Other examples of tools and icons on annotation toolbar (319) may include a standard view mode (322), draw a hollow rectangle (323), highlight an item (324), revert to last saved (325), draw a freehand line (326), rubber stamp (327), select and move items (328), draw a filled rectangle (329), save the annotations (330), draw a straight line (331), and write on an image (332). Each of these functions has been discussed above, and their respective operations are individually well known in the art.

Although this invention has been described with reference to particular embodiments, it will be appreciated that many variations will be resorted to without departing from the spirit and scope of this invention as set forth in the appended claims. For example, the terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, a digital watch and the like. Further, a computer, computer system, or system of the invention may operate in communication with other systems over a communication network, such as, for example, the Internet, an intranet, or an extranet, or may operate as a stand-alone system.

What is claimed is:

1. A user interface system for processing documents for display, comprising:
a user command interface for receiving one or more user commands;
a source of template image overlays;
a document processor for retrieving a text portion of a document and document type information for said document from storage and for selecting an image overlay from said source in response to said document type information; and
a display processor for processing said document text portion to align with said selected image overlay in response to said document type information to produce data representing an aligned text image.

2. The system of claim 1, wherein said document type information includes information for identifying an image overlay from a plurality of available predetermined image overlays and text registration information comprising at least one of, (a) font type, (b) font size, (c) start character position information, and (d) page break identification information.

3. The system of claim 1, wherein said display processor processes said document text portion to align with said selected image overlay to produce data representing a composite image for display.

4. The system of claim 1, wherein said text portion of said document comprises a whole document.

5. The system of claim 1, wherein said display processor aligns said document text portion with said selected image overlay in response to a user command received via said user command interface.

6. The system of claim 1, wherein said display processor processes said document text portion and image overlay information to produce data representing a composite image including at least one annotation, for display.

7. The system of claim 6, wherein said at least one annotation is derived from a storage source different to a source of said document text portion and comprises at least one, (a) a text annotation, (b) a sticky note text annotation, (c) a rubber stamp annotation, (d) a graphic annotation, (e) a highlight annotation, and (f) a signature capture annotation.

8. The system of claim 1, wherein said display processor is programmed for one or more functions selected from the group consisting of zooming of said document, rotating of said document, reading text files that have been compressed using the GZIP algorithm, progressive loading of text documents; searching said portion of said data object, copying said portion of said data object, printing said portion of said data object, and printing said information for said data object.

9. A method of providing a user interface system for processing documents for display, comprising the steps of:
receiving one or more user commands;
retrieving a text portion of a document and document type information for said document from storage;
selecting an image overlay from a source of template image overlays in response to said document type information; and
processing said document text portion to align with said selected image overlay in response to said document type information to produce data representing an aligned text image.

10. The method of claim 9, further comprising the step of generating a template file containing at least a portion of said image and text information.

11. A user interface system for processing documents for display, comprising:
a user interface for receiving one or more user commands;
a source of annotations separate from a source of document text;
a document processor for retrieving a text portion of a document and an annotation and document type information; and
a display processor for processing said document text portion and said annotation to produce data representing a composite image including at least one annotation, for display, in response to said document type information.

12. The system of claim 11, wherein said display processor processes said document text portion and image overlay information derived using said document type information to produce data representing a composite image including text aligned with a selected image overlay and at least one annotation, for display.

13. The system of claim 12, wherein said at least one annotation is derived from a storage source different to a source of said document text portion and comprises at least one, (a) a text annotation, (b) a sticky note text annotation, (c) a rubber stamp annotation, (d) a graphic annotation, (e) a highlight annotation, and (f) a signature capture annotation.

14. An apparatus for managing data objects within a document-imaging system comprising:
a user interface for receiving one or more user commands;
an object processor for retrieving at least a portion of said data object from said document imaging system and rendering said portion of said data object for viewing on said user interface, wherein said object processor is programmed for receiving and storing image and text information for said data object in response to said user command.

15. The apparatus of claim 14, wherein said object processor comprises a document navigation processor for providing navigation in said data object in response to said user command.

16. The apparatus of claim 14, wherein said object processor comprises a rendering processor for generating a template file containing at least a portion of said image and text information.

17. The apparatus of claim 14, wherein said information comprises one or more annotations selected from the group consisting of a text annotation, a sticky note text annotation, a rubber stamp annotation, a graphic annotation, a highlight annotation, and a signature capture annotation.

18. The apparatus of claim 14, wherein said object processor is further programmed for one or more functions selected from the group consisting of zooming of said document, rotating of said document, reading text files that have been compressed using the GZIP algorithm, progressive loading of text documents; searching said portion of said data object, copying said portion of said data object, printing said portion of said data object, and printing said information for said data object.

19. The apparatus of claim 14, further comprising an interoperability interface programmed for communicating with applications external to said document-imaging system.

20. A method for managing data objects within a document-imaging system comprising the steps of:
retrieving at least a portion of said data object from said document imaging system;
rendering said portion of said data object for viewing on a user interface,
receiving and storing image and text information for said data object in response to user command.

21. The method of claim 20, further comprising the step of providing navigation in said data object in response to said user command.

22. The method of claim 20, further comprising the steps of generating a template file containing at least a portion of said image and text information.

23. The method of claim 20, wherein said information comprises one or more annotations selected from the group consisting of a text annotation, a sticky note text annotation, a rubber stamp annotation, a graphic annotation, a highlight annotation, and a signature capture annotation.

24. The method of claim 20, wherein said step of retrieving said portion of said data object is performed in response to user command.

25. The method of claim 20, wherein said step of retrieving said portion of said data object is performed in response to command from an application external to said document-imaging system.
